(19) United States
(12) Patent Application Publication
(10) Pub. No.: US 2026/0250570 A1
(43) Pub. Date: Aug. 27, 2026

(54) CORROSION INHIBITOR COMPOSITIONS AND METHODS OF USE THEREOF

(71) Applicant: ChampionX LLC, Sugar Land, TX (US)

(72) Inventors: Tri T. Phan, Sugar Land, TX (US); Jeremy Moloney, Katy, TX (US); Mi Thuy Bui, Houston, TX (US)

(21) Appl. No.: 19/549,391

(22) Filed: Feb. 25, 2026

Related U.S. Application Data
(60) Provisional application No. 63/763,084, filed on Feb. 25, 2025.

(51) Int. Cl. C09K 8/54; C09K 8/60; C09K 8/82; E21B 41/02

(52) U.S. Cl. CPC C09K 8/54; C09K 8/602; C09K 8/82; E21B 41/02; C09K 2208/32

(57) ABSTRACT

The present disclosure describes compositions comprising an oil-soluble corrosion inhibitor and methods of inhibiting corrosion using the corrosion inhibitor compositions. The oil-soluble corrosion inhibitors can be imidazoline compounds, quaternary ammonium compounds, a mixture of dimerized fatty acids and trimerized fatty acids, a polyamide resin, a maleated fatty acid, an alkoxylated unsaturated fatty acid dimer, a tall oil fatty acid, or a combination thereof. The corrosion inhibitor compositions further comprise a nonionic surfactant having a cloud point of equal to or less than 35° C. at a concentration of 1 wt. % actives. These corrosion inhibitor compositions can be used to treat a subterranean hydrocarbon-containing reservoir and can inhibit or reduce corrosion in a piece of equipment in contact with the reservoir.

### CROSS-REFERENCE TO RELATED APPLICATIONS

This patent application claims the benefit of U.S. Provisional Patent Application No. 63/763,084, filed Feb. 25, 2025; the entire disclosure of which is incorporated herein by reference.

### FIELD

The present disclosure describes compositions comprising an oil-soluble corrosion inhibitor and methods of inhibiting corrosion using the corrosion inhibitor compositions. The oil-soluble corrosion inhibitors can be imidazoline compounds, quaternary ammonium compounds, a mixture of dimerized fatty acids and trimerized fatty acids, a polyamide resin, a maleated fatty acid, an alkoxylated unsaturated fatty acid dimer, a tall oil fatty acid, or a combination thereof. The corrosion inhibitor compositions further comprise a nonionic surfactant having a cloud point of equal to or less than 35° C. at a concentration of 1 wt. % actives. These corrosion inhibitor compositions can be used to treat a subterranean hydrocarbon-containing reservoir and can inhibit or reduce corrosion in a piece of equipment in contact with the reservoir.

### BACKGROUND

One of the greatest risks to oil and gas production infrastructure is accelerated internal pipeline corrosion, particularly as a field ages and water cut rises. The production of oil and gas reservoirs present corrosive environments that place the internal metallurgy of process equipment (e.g., transport pipelines, flow lines, separation equipment), often constructed of mild carbon steel, at risk for failure. The rate of corrosion deterioration in oil and gas field equipment metallurgy is dependent upon production parameters such as oil/water ratio, fluid brine composition, temperature, pH, and the concentration of corrosive gases typically present in the reservoir formation, such as CO₂, H₂S, or combinations thereof.

In order to preserve the integrity of oil and gas infrastructure, corrosion inhibitors are typically added into the production fluids upstream of piping infrastructure intended to be protected. In general, corrosion inhibitors of this type protect the metal through formation of a passivation film on the metal surface. This passivation layer oil wets the metal surface, which in turn prevents contact of the metal from the corrosive nature of the produced reservoir fluids. Typically, corrosion inhibitor formulations of this type contain a variety of aliphatic organic surfactant molecules ranging from, but not limited to, amines, quaternary amines, imidazolines, phosphate esters, amides, carboxylic acids, or combinations thereof.

In some cases, these corrosion inhibitors are oil-soluble and they do not disperse in aqueous media effectively. Thus, these oil-soluble corrosion inhibitors can be less likely to reach the surfaces in the hydrocarbon reservoir extraction system that need to be protected from corrosion.

Thus, despite the availability and effectiveness of corrosion inhibitors for use in the oil and gas industry, there still exists a need for improved compositions, and methods having greater effectiveness.

### SUMMARY

This disclosure describes a corrosion inhibitor composition comprising a nonionic surfactant and an oil-soluble corrosion inhibitor, the surfactant comprising a nonionic surfactant having a cloud point of equal to or less than 35° C. at a concentration of 1 wt. % actives; and the oil-soluble corrosion inhibitor comprising one or more of the following agents: (i) an imidazoline compound having the structure of Formula 1:

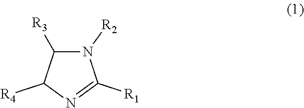

wherein R₁ is C₁ to C₂₃ alkyl or C₁ to C₂₃ alkenyl; R₃ and R₄ are independently hydrogen or C₁ to C₆ alkyl; R₂ is C₁ to C₆ alkyl substituted with —N(R₅)(R₆) or —NHC(O)R₇, R₅ and R₆ are independently hydrogen or —C(O)R₈; R₇ is C₁₀ to C₂₀ alkyl or C₁₀ to C₂₀ alkenyl; and R₈ is hydrogen or C₁ to C₆ alkyl; or a tautomer thereof; (ii) a quaternary ammonium compound having the structure of Formula 2

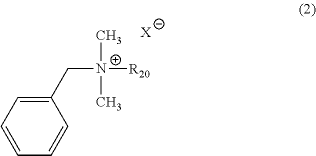

wherein R₂₀ is C₆ to C₂₀ alkyl or C₆ to C₂₀ alkenyl; (iii) a mixture of dimerized fatty acids and trimerized fatty acids; (iv) a reaction product of polyalkylenepolyamines and fatty acids (C₁₈ unsaturated dimers); (v) a maleated fatty acid (C₁₂-C₁₈ fatty acid); (vi) an alkoxylated unsaturated fatty acid dimer; or (vii) a C₁₂-C₁₈ fatty acid; and optionally, a solvent.

Another aspect of the disclosure is a method for treating a subterranean hydrocarbon-containing reservoir comprising contacting a hydrocarbon fluid with the corrosion inhibitor composition described herein.

Other objects and features will be in part apparent and in part pointed out hereinafter.

### DESCRIPTION OF THE PREFERRED EMBODIMENTS

The present disclosure describes various corrosion inhibitor compositions comprising an oil-soluble corrosion inhibitor and a non-ionic surfactant having a cloud point of equal to or less than 35° C. at a concentration of 1 wt. % actives. Corrosion inhibitors are applied to prevent corrosion on metal surface of equipment, tubing, casing, pipelines, and vessels in the oil and gas industry. Corrosion inhibitors provide protection by forming a film of corrosion inhibitor molecules on the metal surface. Typically, oil-soluble corrosion inhibitors form a more persistent film, and are therefore more effective to inhibit corrosion, than water-soluble corrosion inhibitors. However, oil-soluble corrosion inhibitors do not efficiently disperse into water, and therefore, these oil-soluble corrosion inhibitors partition with oil phases in the reservoir or otherwise agglomerate and do not flow with aqueous injection fluids to contact the metal surfaces that need corrosion protection. Described herein are surfactants that enhance dispersion of oil-soluble corrosion inhibitors when blended into the corrosion inhibitor compositions and these surfactants enable the oil-soluble corrosion inhibitors to be transported throughout the system and to contact the metal surface that needs to be protected from corrosion.

This disclosure describes a corrosion inhibitor composition comprising a nonionic surfactant and an oil-soluble corrosion inhibitor, the nonionic surfactant having a cloud point of equal to or less than 35° C. at a concentration of 1 wt. % actives and the oil-soluble corrosion inhibitor comprising one or more of the following agents: (i) an imidazoline compound having the structure of Formula 1:

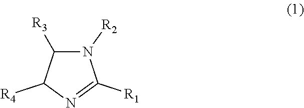

wherein R₁ is C₁₀ to C₂₃ alkyl or C₁₀ to C₂₃ alkenyl; R₃ and R₄ are independently hydrogen or C₁ to C₆ alkyl; R₂ is C₁ to C₆ alkyl substituted with —N(R₅)(R₆) or —NHC(O)R₇, R₅ and R₆ are independently hydrogen or —C(O)R₈; R₇ is C₁₀ to C₂₀ alkyl or C₁₀ to C₂₀ alkenyl; and R₈ is hydrogen or C₁ to C₆ alkyl; or a tautomer thereof; (ii) a dimer fatty acid, a trimer fatty acid, or a combination thereof; (iii) a tall oil fatty acid or maleated tall oil fatty acid; (iv) a fatty amide polymer; or (v) an alkoxylated unsaturated fatty acid or fatty acid dimer.

The corrosion inhibitor compositions can have the nonionic surfactant comprise an alkoxylated alkylphenol, an alkoxylated alcohol, an ethylene oxide/propylene oxide copolymer, or a combination thereof.

Further, the corrosion inhibitor compositions can have the nonionic surfactant comprise an ethoxylated octylphenol having an average of 5 to 10 ethylene oxide units per molecule, an ethoxylated nonylphenol having an average of 6 to 12 ethylene oxide units per molecule, an ethoxylated branched secondary alcohol having an average of 6 to 10 ethylene oxide units per molecule, and ethoxylated isodecyl alcohol having an average of 4 to 8 ethylene oxide units per molecule, or a combination thereof.

Also, the corrosion inhibitor compositions can have the nonionic surfactant comprise an ethoxylated octylphenol having an average of 5 to 10 ethylene oxide units per molecule; or the surfactant can comprise an ethoxylated octylphenol having an average of 9 or 10 ethylene oxide units per molecule.

The corrosion inhibitor compositions can further comprise an anionic surfactant.

The corrosion inhibitor compositions can have the anionic surfactant comprise a C₁₀-C₂₀ alkyl benzyl sulfonic acid.

Also, the corrosion inhibitor compositions can have the anionic surfactant comprise decyl benzyl sulfonic acid, dodecyl benzyl sulfonic acid, tetradecyl benzyl sulfonic acid, or a combination thereof.

The corrosion inhibitor compositions can have the anionic surfactant comprise linear dodecyl benzyl sulfonic acid.

The corrosion inhibitor compositions described herein can further comprise a quaternary ammonium compound having the structure of Formula 2

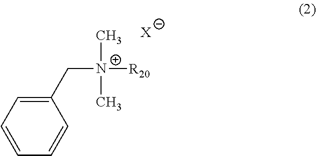

wherein R₂₀ is C₆ to C₂₀ alkyl or C₆ to C₂₀ alkenyl.

The corrosion inhibitor compositions can have the quaternary ammonium compounds of Formula 2 have R₂₀ be C₈ to C₁₈ alkyl, R₂₀ be C₈ to C₁₆ alkyl, or R₂₀ be C₈ to C₁₂ alkyl.

For preferred corrosion inhibitor compositions described herein, the quaternary ammonium compounds of Formula 2 have R₂₀ of C₈ to C₁₀ alkyl.

Yet further, the corrosion inhibitor compositions can further comprise a pH adjusting agent and the pH adjusting agent can comprise an alkylamine or an alkanolamine.

The corrosion inhibitor compositions can also further comprise a pH adjusting agent and the pH adjusting agent can comprise the alkylamine.

When the corrosion inhibitor compositions have the pH adjusting agent comprise the alkylamine, the alkylamine can comprise ethanol, 2/2′-oxybis-, reaction products with ammonia, morpholine derivatives and residues.

The corrosion inhibitor compositions can have the pH adjusting agent comprise the alkanolamine.

For the corrosion inhibitor compositions where the pH adjusting agent comprises the alkanolamine, the alkanolamine can comprise monoethanolamine.

The corrosion inhibitor compositions can also include and emulsion breaking agent that is an alkylaryl sulfonate.

In some cases, the alkylaryl sulfonate is a naphthalenesulfonic acid, bis(1-methylethyl)-, compound with 1-butanamine (1:1).

The corrosion inhibitor compositions can also have the oil-soluble corrosion inhibitor be the imidazoline compound having the structure of Formula 1.

For the corrosion inhibitor compositions having the oil-soluble corrosion inhibitor be the imidazoline compound having the structure of Formula 1, R₁ can be C₁₅ to C₂₃ alkyl or C₁₅ to C₂₃ alkenyl or R₁ can be C₁₇ to C₁₉ alkyl or C₁₇ to C₁₉ alkenyl.

For the corrosion inhibitor compositions having the oil-soluble corrosion inhibitor be the imidazoline compound having the structure of Formula 1, R₁ can be C₁₇ alkenyl.

For the corrosion inhibitor compositions having the oil-soluble corrosion inhibitor be the imidazoline compound having the structure of Formula 1, R₂ can be C₁ to C₆ alkyl substituted with —N(R₅)(R₆) or R₂ can be C₂ to C₄ alkyl substituted with —N(R₅)(R₆).

For the corrosion inhibitor compositions having the oil-soluble corrosion inhibitor be the imidazoline compound having the structure of Formula 1, R₂ can be C₂ or C₃ alkyl substituted with —N(R₅)(R₆).

For the corrosion inhibitor compositions having the oil-soluble corrosion inhibitor be the imidazoline compound having the structure of Formula 1, R₅ and R₆ can be hydrogen.

For the corrosion inhibitor compositions having the oil-soluble corrosion inhibitor be the imidazoline compound having the structure of Formula 1, R₃ and R₄ can be independently hydrogen or C₁ to C₃ alkyl.

For the corrosion inhibitor compositions having the oil-soluble corrosion inhibitor be the imidazoline compound having the structure of Formula 1, R₃ and R₄ can be hydrogen.

The corrosion inhibitor compositions described herein can have the oil-soluble corrosion inhibitor comprise a dimerized fatty acid, a trimerized fatty acid, or a combination thereof.

The corrosion inhibitor compositions can have the dimerized fatty acid be a C₃₆-dimerized fatty acid.

The corrosion inhibitor compositions can have the trimerized fatty acid be a C₅₄-trimerized fatty acid.

The corrosion inhibitor compositions can have the oil-soluble corrosion inhibitor comprise a mixture of dimerized fatty acids and trimerized fatty acids.

The corrosion inhibitor compositions can have the mixture of dimerized fatty acids and trimerized fatty acids be a C₃₆-dimerized fatty acid and a C₅₄-trimerized fatty acid.

The corrosion inhibitor compositions can also have the oil-soluble corrosion inhibitors comprise a reaction product of polyalkylenepolyamines and fatty acids, wherein the fatty acids are C₁₆-C₂₄ unsaturated dimers. Preferably, these oil-soluble corrosion inhibitors are reaction products of C₁₈ unsaturated fatty acids and dimers with polyethylenepolyamines.

Additionally, the corrosion inhibitor compositions can have the oil-soluble corrosion inhibitors be reaction products of C₁₈ unsaturated dimers with polyalkyleneamines.

The corrosion inhibitor compositions described herein can have the oil-soluble corrosion inhibitor comprise a maleated C₁₆-C₂₄ fatty acid.

The corrosion inhibitor compositions can have the oil-soluble corrosion inhibitor comprise a maleated tall oil fatty acid.

Also, the corrosion inhibitor compositions can have the oil-soluble corrosion inhibitor comprise the alkoxylated unsaturated fatty acid dimer.

The corrosion inhibitor compositions can have the oil-soluble corrosion inhibitor be the alkoxylated unsaturated fatty acid dimer that comprises an ethoxylated C₁₈-unsaturated fatty acid dimer.

The corrosion inhibitor compositions can have the oil-soluble corrosion inhibitor comprise the tall oil fatty acid or maleated tall oil fatty acid.

Further, the corrosion inhibitor compositions can have the solvent comprise an aromatic solvent, ethylene glycol monobutyl ether (EGMBE), methanol, isopropyl alcohol, water, or a combination thereof.

The corrosion inhibitor compositions can have the solvent comprise from about 1 wt. % to about 90 wt. % based on the total weight of the corrosion inhibitor composition. The corrosion inhibitor compositions can also have the solvent be present at a concentration of from about 1 wt. % to about 80 wt. %, from about 1 wt. % to about 70 wt. %, from about 1 wt. % to about 60 wt. %, from about 1 wt. % to about 50 wt. %, from about 1 wt. % to about 40 wt. %, from about 1 wt. % to about 30 wt. %, from about 1 wt. % to about 20 wt. %, from about 10 wt. % to about 80 wt. %, from about 10 wt. % to about 70 wt. %, from about 10 wt. % to about 60 wt. %, from about 10 wt. % to about 50 wt. %, from about 10 wt. % to about 40 wt. %, from about 10 wt. % to about 30 wt. %, from about 10 wt. % to about 20 wt. %, from about 20 wt. % to about 80 wt. %, from about 20 wt. % to about 70 wt. %, from about 20 wt. % to about 60 wt. %, from about 20 wt. % to about 50 wt. %, from about 20 wt. % to about 40 wt. %, or from about 20 wt. % to about 30 wt. % based on the total weight of the corrosion inhibitor composition.

The corrosion inhibitor compositions can also have the pH adjusting agent comprise from about 1 wt. % to about 20 wt. % based on the total weight of the corrosion inhibitor composition. The corrosion inhibitor compositions can also have the pH adjusting agent have a concentration from about 1 wt. % to about 15 wt. %, from about 1 wt. % to about 10 wt. %, from about 1 wt. % to about 5 wt. %, from about 2 wt. % to about 15 wt. %, from about 2 wt. % to about 10 wt. %, or from about 2 wt. % to about 5 wt. % based on the total weight of the corrosion inhibitor composition.

The corrosion inhibitor compositions can further have the oil-soluble corrosion inhibitor comprise from about 1 wt. % to about 90 wt. % based on the total weight of the corrosion inhibitor composition. The corrosion inhibitor compositions can also have the oil-soluble corrosion inhibitor comprise from about 1 wt. % to about 80 wt. %, from about 1 wt. % to about 70 wt. %, from about 1 wt. % to about 60 wt. %, from about 1 wt. % to about 50 wt. %, from about 10 wt. % to about 80 wt. %, from about 10 wt. % to about 70 wt. %, from about 10 wt. % to about 60 wt. %, from about 10 wt. % to about 50 wt. %, from about 20 wt. % to about 80 wt. %, from about 20 wt. % to about 70 wt. %, from about 20 wt. % to about 60 wt. %, or from about 20 wt. % to about 50 wt. % based on the total weight of the corrosion inhibitor composition.

The corrosion inhibitor compositions can have the nonionic surfactant comprise from about 1 wt. % to about 20 wt. % based on the total weight of the corrosion inhibitor composition. The corrosion inhibitor compositions can also have the nonionic surfactant have a concentration from about 1 wt. % to about 15 wt. %, from about 1 wt. % to about 10 wt. %, from about 1 wt. % to about 5 wt. %, from about 1 wt. % to about 4 wt. %, from about 1 wt. % to about 3 wt. %, or from about 1 wt. % to about 2 wt. % based on the total weight of the corrosion inhibitor composition.

Also, the corrosion inhibitor compositions can have the quaternary ammonium compound comprise from about 1 wt. % to about 80 wt. % based on the total weight of the corrosion inhibitor composition. The corrosion inhibitor compositions can also have the quaternary ammonium compound comprise from about 1 wt. % to about 70 wt. %, from about 1 wt. % to about 60 wt. %, from about 1 wt. % to about 50 wt. %, from about 1 wt. % to about 40 wt. %, from about 1 wt. % to about 30 wt. %, from about 10 wt. % to about 80 wt. %, from about 10 wt. % to about 70 wt. %, from about 10 wt. % to about 60 wt. %, from about 10 wt. % to about 50 wt. %, from about 10 wt. % to about 40 wt. %, from about 10 wt. % to about 30 wt. %, from about 20 wt. % to about 80 wt. %, from about 20 wt. % to about 70 wt. %, from about 20 wt. % to about 60 wt. %, from about 20 wt. % to about 50 wt. %, from about 20 wt. % to about 40 wt. %, or from about 20 wt. % to about 30 wt. % based on the total weight of the corrosion inhibitor composition.

The oil-soluble corrosion inhibitor component of the corrosion inhibitor compositions can be a film-forming corrosion inhibitor. The film-forming corrosion inhibitors are the dimer fatty acids, trimer fatty acids, or a combination of dimer fatty acids and trimer fatty acids; tall oil fatty acids, maleated tall oil fatty acids; fatty amide polymers; or alkoxylated unsaturated fatty acids or alkoxylated unsaturated fatty acid dimers.

The film-forming corrosion inhibitor can be present in the corrosion inhibitor compositions from about 1 wt. % to about 60 wt. % based on the total weight of the corrosion inhibitor composition.

The oil-soluble corrosion inhibitor of Formula (1) can be present in the corrosion inhibitor compositions from about 1 wt. % to about 20 wt. % based on the total weight of the corrosion inhibitor composition. The corrosion inhibitor compositions can also have the oil-soluble corrosion inhibitor of Formula (1) have a concentration from about 1 wt. % to about 15 wt. %, from about 1 wt. % to about 10 wt. %, from about 1 wt. % to about 5 wt. %, from about 1 wt. % to about 4 wt. %, or from about 1 wt. % to about 3 wt. % based on the total weight of the corrosion inhibitor composition.

A composition comprising brine having at least 15,000 mg/L, at least 16,000 mg/L, at least 17,000 mg/L, at least 18,000 mg/L, at least 19,000 mg/L, at least 20,000 mg/L, at least 21,000 mg/L, at least 22,000 mg/L, at least 23,000 mg/L, at least 24,000 mg/L, at least 25,000 mg/L, or more sodium ions, a nonionic surfactant and an oil-soluble corrosion inhibitor, the surfactant comprising a nonionic surfactant having a cloud point of equal to or less than 35° C. at a concentration of 1 wt. % actives; and the oil-soluble corrosion inhibitor comprising one or more of the following agents: (i) an imidazoline compound having the structure of Formula 1:

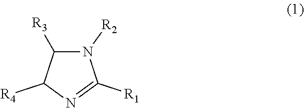

wherein R₁ is C₁ to C₂₃ alkyl or C₁ to C₂₃ alkenyl; R₃ and R₄ are independently hydrogen or C₁ to C₆ alkyl; R₂ is C₁ to C₆ alkyl substituted with —N(R₅)(R₆) or —NHC(O)R₇, R₅ and R₆ are independently hydrogen or —C(O)R₈; R₇ is C₁₀ to C₂₀ alkyl or C₁₀ to C₂₀ alkenyl; and R₈ is hydrogen or C₁ to C₆ alkyl; or a tautomer thereof; (ii) a quaternary ammonium compound having the structure of Formula 2

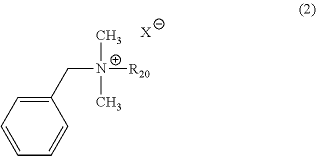

wherein R₂₀ is C₆ to C₂₀ alkyl or C₆ to C₂₀ alkenyl; (iii) a mixture of dimerized fatty acids and trimerized fatty acids; (iv) a reaction product of polyalkylenepolyamines and fatty acids (C₁₈ unsaturated dimers); (v) a maleated fatty acid (C₁₂-C₁₈ fatty acid); (vi) an alkoxylated unsaturated fatty acid dimer; or (vii) a C₁₂-C₁₈ fatty acid; and optionally, a solvent.

The composition comprising brine above further comprising a hydrocarbon.

The composition comprising brine, wherein the hydrocarbon is a crude oil.

The composition comprising brine further comprising the corrosion inhibitor composition described herein.

Also disclosed herein are methods for treating a subterranean hydrocarbon-containing reservoir comprising contacting a hydrocarbon fluid with the corrosion inhibitor compositions disclosed herein.

The methods disclosed herein, wherein the corrosion inhibitor compositions inhibit or reduce corrosion in a piece of equipment in contact with the hydrocarbon-containing reservoir.

Additionally, the methods of treating a subterranean hydrocarbon-containing reservoir comprising adding the corrosion inhibitor composition at a concentration of from about 1 ppm to about 1000 ppm, from about 1 ppm to about 750 ppm, from about 1 ppm to about 500 ppm, from about 1 ppm to about 400 ppm, from about 1 ppm to about 300 ppm, from about 1 ppm to about 250 ppm, from about 1 ppm to about 200 ppm, from about 1 ppm to about 150 ppm, from about 1 ppm to about 100 ppm, from about 1 ppm to about 75 ppm, from about 1 ppm to about 50 ppm, from about 5 ppm to about 1000 ppm, from about 5 ppm to about 750 ppm, from about 5 ppm to about 500 ppm, from about 5 ppm to about 400 ppm, from about 5 ppm to about 300 ppm, from about 5 ppm to about 250 ppm, from about 5 ppm to about 200 ppm, from about 5 ppm to about 150 ppm, from about 5 ppm to about 100 ppm, from about 5 ppm to about 75 ppm, from about 5 ppm to about 50 ppm, from about 10 ppm to about 1000 ppm, from about 10 ppm to about 750 ppm, from about 10 ppm to about 500 ppm, from about 10 ppm to about 400 ppm, from about 10 ppm to about 300 ppm, from about 10 ppm to about 250 ppm, from about 10 ppm to about 200 ppm, from about 10 ppm to about 150 ppm, from about 10 ppm to about 100 ppm, from about 10 ppm to about 75 ppm, or from about 10 ppm to about 50 ppm, based on the total weight of an injection fluid.

The solid compositions described herein can be administered to a reservoir with various agents simultaneously or close in time. For example, the solid compositions can be administered with an agent selected from the group consisting of an organic solvent, an asphaltene inhibitor, a paraffin inhibitor, a scale inhibitor, an emulsifier, a water clarifier, a dispersant, an emulsion breaker, a gas hydrate inhibitor, a biocide, a pH modifier, a surfactant, and a combination thereof.

The agent can comprise an organic solvent. The organic solvent can comprise an alcohol, a hydrocarbon, a ketone, an ether, an alkylene glycol, a glycol ether, an amide, a nitrile, a sulfoxide, an ester, or a combination thereof. Examples of suitable organic solvents include, but are not limited to, methanol, ethanol, propanol, isopropanol, butanol, 2-ethylhexanol, hexanol, octanol, decanol, 2-butoxyethanol, methylene glycol, ethylene glycol, 1,2-propylene glycol, 1,3-propylene glycol, diethyleneglycol monomethyl ether, diethylene glycol monoethyl ether, ethylene glycol monobutyl ether, ethylene glycol dibutyl ether, pentane, hexane, cyclohexane, methylcyclohexane, heptane, decane, dodecane, diesel, toluene, xylene, heavy aromatic naphtha, cyclohexanone, diisobutylketone, diethyl ether, propylene carbonate, N-methylpyrrolidinone, N, N-dimethylformamide, or a combination thereof.

The agent can comprise a corrosion inhibitor.

The agent can comprise an organic sulfur compound, such as a mercaptoalkyl alcohol, mercaptoacetic acid, thioglycolic acid, 3,3′-dithiodipropionic acid, sodium thiosulfate, thiourea, L-cysteine, tert-butyl mercaptan, sodium thiosulfate, ammonium thiosulfate, sodium thiocyanate, ammonium thiocyanate, sodium metabisulfite, or a combination thereof. Preferably, the mercaptoalkyl alcohol comprises 2-mercaptoethanol.

The agent can further include a demulsifier. Preferably, the demulsifier comprises an oxyalkylate polymer, such as a polyalkylene glycol.

The agent can include an asphaltene inhibitor. Suitable asphaltene inhibitors include, but are not limited to, aliphatic sulfonic acids; alkyl aryl sulfonic acids; aryl sulfonates; lignosulfonates; alkylphenol/aldehyde resins and similar sulfonated resins; polyolefin esters; polyolefin imides; polyolefin esters with alkyl, alkylenephenyl or alkylenepyridyl functional groups; polyolefin amides; polyolefin amides with alkyl, alkylenephenyl or alkylenepyridyl functional groups; polyolefin imides with alkyl, alkylenephenyl or alkylenepyridyl functional groups; alkenyl/vinyl pyrrolidone copolymers; graft polymers of polyolefins with maleic anhydride or vinyl imidazole; hyperbranched polyester amides; polyalkoxylated asphaltenes, amphoteric fatty acids, salts of alkyl succinates, sorbitan monooleate, and polyisobutylene succinic anhydride.

The agent can include an additional paraffin inhibitor. Suitable additional paraffin inhibitors include, but are not limited to, paraffin crystal modifiers, and dispersant/crystal modifier combinations. Suitable paraffin crystal modifiers include, but are not limited to, alkyl acrylate copolymers, alkyl acrylate vinylpyridine copolymers, ethylene vinyl acetate copolymers, maleic anhydride ester copolymers, branched polyethylenes, naphthalene, anthracene, microcrystalline wax and/or asphaltenes. Suitable paraffin dispersants include, but are not limited to, dodecyl benzene sulfonate, oxyalkylated alkylphenols, and oxyalkylated alkylphenolic resins.

The agent can include a scale inhibitor. Suitable scale inhibitors include, but are not limited to, phosphates, phosphate esters, phosphoric acids, phosphonates, phosphonic acids, polyacrylamides, salts of acrylamidomethyl propane sulfonate/acrylic acid copolymer (AMPS/AA), phosphinated maleic copolymer (PHOS/MA), and salts of a polymaleic acid/acrylic acid/acrylamidomethyl propane sulfonate terpolymer (PMA/AA/AMPS).

The agent can include an emulsifier. Suitable emulsifiers include, but are not limited to, salts of carboxylic acids, products of acylation reactions between carboxylic acids or carboxylic anhydrides and amines, and alkyl, acyl and amide derivatives of saccharides (alkyl-saccharide emulsifiers).

The agent can include a water clarifier. Suitable water clarifiers include, but are not limited to, inorganic metal salts such as alum, aluminum chloride, and aluminum chlorohydrate, or organic polymers such as acrylic acid based polymers, acrylamide based polymers, polymerized amines, alkanolamines, thiocarbamates, and cationic polymers such as diallyldimethylammonium chloride (DADMAC).

The agent can include a dispersant. Suitable dispersants include, but are not limited to, aliphatic phosphonic acids with 2-50 carbons, such as hydroxyethyl diphosphonic acid, and aminoalkyl phosphonic acids, e.g. polyaminomethylene phosphonates with 2-10 N atoms e.g. each bearing at least one methylene phosphonic acid group; examples of the latter are ethylenediamine tetra(methylene phosphonate), diethylenetriamine penta(methylene phosphonate), and the triamine- and tetramine-polymethylene phosphonates with 2-4 methylene groups between each N atom, at least 2 of the numbers of methylene groups in each phosphonate being different. Other suitable dispersion agents include lignin, or derivatives of lignin such as lignosulfonate and naphthalene sulfonic acid and derivatives.

The agent can include an emulsion breaker. Suitable emulsion breakers include, but are not limited to, dodecylbenzylsulfonic acid (DDBSA), the sodium salt of xylenesulfonic acid (NAXSA), epoxylated and propoxylated compounds, anionic, cationic and nonionic surfactants, and resins, such as phenolic and epoxide resins.

The agent can include a hydrogen sulfide scavenger. Suitable additional hydrogen sulfide scavengers include, but are not limited to, oxidants (e.g., inorganic peroxides such as sodium peroxide or chlorine dioxide); aldehydes (e.g., of 1-10 carbons such as formaldehyde, glyoxal, glutaraldehyde, acrolein, or methacrolein; triazines (e.g., monoethanolamine triazine, monomethylamine triazine, and triazines from multiple amines or mixtures thereof); condensation products of secondary or tertiary amines and aldehydes, and condensation products of alkyl alcohols and aldehydes.

The agent can include a gas hydrate inhibitor. Suitable gas hydrate inhibitors include, but are not limited to, thermodynamic hydrate inhibitors (THI), kinetic hydrate inhibitors (KHI), and anti-agglomerates (AA). Suitable thermodynamic hydrate inhibitors include, but are not limited to, sodium chloride, potassium chloride, calcium chloride, magnesium chloride, sodium bromide, formate brines (e.g. potassium formate), polyols (such as glucose, sucrose, fructose, maltose, lactose, gluconate, monoethylene glycol, diethylene glycol, triethylene glycol, mono-propylene glycol, dipropylene glycol, tripropylene glycols, tetrapropylene glycol, monobutylene glycol, dibutylene glycol, tributylene glycol, glycerol, diglycerol, triglycerol, and sugar alcohols (e.g. sorbitol, mannitol)), methanol, propanol, ethanol, glycol ethers (such as diethyleneglycol monomethylether, ethyleneglycol monobutylether), and alkyl or cyclic esters of alcohols (such as ethyl lactate, butyl lactate, methylethyl benzoate).

The agent can include a kinetic hydrate inhibitor. Suitable kinetic hydrate inhibitors and anti-agglomerates include, but are not limited to, polymers and copolymers, polysaccharides (such as hydroxyethylcellulose (HEC), carboxymethylcellulose (CMC), starch, starch derivatives, and xanthan), lactams (such as polyvinylcaprolactam, polyvinyl lactam), pyrrolidones (such as polyvinyl pyrrolidone of various molecular weights), surfactants (such as fatty acid salts, ethoxylated alcohols, propoxylated alcohols, sorbitan esters, ethoxylated sorbitan esters, polyglycerol esters of fatty acids, alkyl glucosides, alkyl polyglucosides, alkyl sulfates, alkyl sulfonates, alkyl ester sulfonates, alkyl aromatic sulfonates, alkyl betaine, alkyl amido betaines), hydrocarbon based dispersants (such as lignosulfonates, iminodisuccinates, polyaspartates), amino acids, and proteins.

The agent can include a biocide. Suitable biocides include, but are not limited to, oxidizing and non-oxidizing biocides. Suitable non-oxidizing biocides include, for example, aldehydes (e.g., formaldehyde, glutaraldehyde, and acrolein), amine-type compounds (e.g., quaternary amine compounds and cocodiamine), halogenated compounds (e.g., 2-bromo-2-nitropropane-3-diol (Bronopol) and 2-2-dibromo-3-nitrilopropionamide (DBNPA)), sulfur compounds (e.g., isothiazolone, carbamates, and metronidazole), and quaternary phosphonium salts (e.g., tetrakis(hydroxymethyl)-phosphonium sulfate (THPS)). Suitable oxidizing biocides include, for example, sodium hypochlorite, trichloroisocyanuric acids, dichloroisocyanuric acid, calcium hypochlorite, lithium hypochlorite, chlorinated hydantoins, stabilized sodium hypobromite, activated sodium bromide, brominated hydantoins, chlorine dioxide, ozone, peroxides, biguanine, formaldehyde releasing preservatives, performic acid, peracetic acid, nitrate, and combinations thereof.

The agent can include a pH modifier. Suitable pH modifiers include, but are not limited to, alkali hydroxides, alkali carbonates, alkali bicarbonates, alkaline earth metal hydroxides, alkaline earth metal carbonates, alkaline earth metal bicarbonates and mixtures or combinations thereof. Exemplary pH modifiers include sodium hydroxide, potassium hydroxide, calcium hydroxide, calcium oxide, sodium carbonate, potassium carbonate, sodium bicarbonate, potassium bicarbonate, magnesium oxide, and magnesium hydroxide.

The agent can include a surfactant. Suitable surfactants include, but are not limited to, anionic surfactants and nonionic surfactants. Anionic surfactants include alkyl aryl sulfonates, olefin sulfonates, paraffin sulfonates, alcohol sulfates, alcohol ether sulfates, alkyl carboxylates and alkyl ether carboxylates, and alkyl and ethoxylated alkyl phosphate esters, and mono and dialkyl sulfosuccinates and sulfosuccinamates. Nonionic surfactants include alcohol alkoxylates, alkylphenol alkoxylates, block copolymers of ethylene, propylene and butylene oxides, alkyl dimethyl amine oxides, alkyl-bis(2-hydroxyethyl) amine oxides, alkyl amidopropyl dimethyl amine oxides, alkylamidopropyl-bis(2-hydroxyethyl) amine oxides, alkyl polyglucosides, polyalkoxylated glycerides, sorbitan esters and polyalkoxylated sorbitan esters, and alkoyl polyethylene glycol esters and diesters. Also included are betaines and sultanes, amphoteric surfactants such as alkyl amphoacetates and amphodiacetates, alkyl amphopropionates and amphodipropionates, and alkyliminodipropionate.

The agent can also include an iron chelator. The iron chelator can be selected from gluconic acid, citric acid, ascorbic acid, tetrakis(hydroxymethyl)phosphonius sulfate (THPS), and combinations thereof.

Compositions used in the methods described herein can further include additional functional agents or additives that provide a beneficial property. For example, additional agents or additives can be sequestrants, solubilizers, lubricants, buffers, cleaning agents, rinse aids, preservatives, binders, thickeners or other viscosity modifiers, processing aids, carriers, water-conditioning agents, foam inhibitors or foam generators, threshold agents or systems, aesthetic enhancing agents (i.e., dyes, odorants, perfumes), or other additives suitable for formulation with a corrosion inhibitor composition, and mixtures thereof. Additional agents or additives will vary according to the particular corrosion inhibitor composition being manufactured and its intend use as one skilled in the art will appreciate.

Alternatively, the compositions used in the methods described herein can not contain any of the additional agents or additives.

Unless otherwise indicated, an alkyl group as described herein alone or as part of another group is an optionally substituted linear saturated monovalent hydrocarbon substituent containing from one to sixty carbon atoms and preferably one to thirty carbon atoms in the main chain or eight to thirty carbon atoms in the main chain, or an optionally substituted branched saturated monovalent hydrocarbon substituent containing three to sixty carbon atoms, and preferably eight to thirty carbon atoms in the main chain. Examples of unsubstituted alkyl groups include methyl, ethyl, n-propyl, i-propyl, n-butyl, i-butyl, s-butyl, t-butyl, n-pentyl, i-pentyl, s-pentyl, t-pentyl, and the like.

The term alkoxy as used herein or alone or as part of another group is an —OR group, wherein the R group is a substituted or unsubstituted alkyl group as defined herein.

The terms “aryl” or “ar” as used herein alone or as part of another group (e.g., aralkyl) denote optionally substituted homocyclic aromatic groups, preferably monocyclic or bicyclic groups containing from 6 to 12 carbons in the ring portion, such as phenyl, biphenyl, naphthyl, substituted phenyl, substituted biphenyl or substituted naphthyl. Phenyl and substituted phenyl are the more preferred aryl. The term “aryl” also includes heteroaryl.

The term “substituted” as in “substituted aryl,” “substituted alkyl,” and the like, means that in the group in question (i.e., the alkyl, aryl or other group that follows the term), at least one hydrogen atom bound to a carbon atom is replaced with one or more substituent groups such as hydroxy (—OH), alkylthio, phosphino, amido (—CON(R_{A})(R_{B}), wherein R_{A} and R_{B} are independently hydrogen, alkyl, or aryl), amino (—N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like. When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

The term “heterocyclo,” “heterocycle,” or “heterocyclyl,” as used herein, refers to a monocyclic, bicyclic, or tricyclic group containing 1 to 4 heteroatoms selected from N, O, S(O)ₙ, P(O)ₙ, PR^{z}, NH or NR^{z}, wherein R^{z} is a suitable substituent. Heterocyclic groups include, but are not limited to, 1,3-oxazetidine, 1,3-diazetidine, 1,3-thiazetidine, oxazolidine, imidazolidine, thiazolidine, 1,3-oxazinane, hexahydropyrimidine, 1,3-thiazinane, 1,3-oxazepane, 1,3-diazepane, 1,3-thiazepane, 1,3-oxazocane, 1,3-diazocane, 1,3-thiazocane. Heterocyclic groups can be unsubstituted or substituted by one or more suitable substituents, preferably 1 to 3 suitable substituents, as defined above.

Having described the disclosure in detail, it will be apparent that modifications and variations are possible without departing from the scope of the invention defined in the appended claims.

### EXAMPLES

The following non-limiting examples are provided to further illustrate the present disclosure.

### Example 1: Corrosion Inhibition Performance Data

Corrosion bubble cell tests were performed using the following conditions for compositions described herein. The tests were performed at 80° C., on C1018 steel using carbon dioxide saturated fluids with the brine described in Table 1 (1 L) without hydrocarbon and with continuous carbon dioxide sparge at atmospheric pressure. After about 3 hours of pre-corrosion time (i.e. with no corrosion inhibitor), 20 ppm actives of the various corrosion inhibitor compositions described in Tables 2-5 below were added to the test cells.

The corrosion rates and the percent inhibition of the tested compositions are presented in Table 6. The percent inhibition was determined by comparing the inhibited corrosion rate at about 15 hours after corrosion inhibitor composition addition and compared with the blank at the same time in the experiment.

TABLE 1
Brine composition

| Ion | Concentration (mg/L) |
|---|---|
| Na⁺ | 25,800 |
| Mg²⁺ | 716 |
| K⁺ | 483 |
| Ca²⁺ | 2,340 |
| Sr²⁺ | 48.3 |
| SO₄²⁻ | 3,479 |
| Br⁻ | 52 |
| Cl⁻ | 39,696 |

TABLE 2
Composition A

| Component | CAS. No | Weight. % |
|---|---|---|
| Aromatic Blend Solvent | 64742-95-6 | 56.74 |
| Methanol | 67-56-1 | 19.09 |
| Isopropanol | 67-63-0 | 1.83 |
| Water | 7732-18-5 | 0.4 |
| Dimer fatty acid | 61788-89-4 | 5.15 |
| Tall Oil Fatty Acid | 61790-12-3 | 2.2 |
| Fatty Amide Polymer | 68410-23-1 | 3.08 |
| Alkylamines | 68909-77-3 | 2.38 |
| benzalkonium chloride | 68424-85-1 | 7.07 |
| Fatty acids, C18-unsatd., dimers, ethoxylated | 68551-92-8 | 1.28 |
| Reaction product of diethylenetriamine and | 61790-69-0 | 0.62 |
| tall-oil (fatty) acid | | |
| Alkylaryl Sulfonate | 151911-63-6 | 0.16 |

| | |
|---|---|
| Total (Wt %) | 100.0 |
| Total active CI (wt %) | 20.30 |

TABLE 3
Composition B

| Component | CAS. No. | Weight % |
|---|---|---|
| 2-Butoxyethanol | 111-76-2 | 14.80 |
| Dimer fatty acid | 61788-89-4 | 20.61 |
| Tall Oil Fatty Acid | 61790-12-3 | 8.81 |
| Fatty Amide Polymer | 68410-23-1 | 12.31 |
| Monoethanolamine | 141-43-5 | 3.14 |
| benzalkonium chloride | 68424-85-1 | 28.28 |
| Fatty acids, C18-unsatd., dimers, | 68551-92-8 | 5.11 |
| ethoxylated | | |
| Tall Oil, Diethylenetriamine | 68442-97-7 | 2.48 |
| Imidazoline | | |
| Alkylaryl Sulfonate | 151911-63-6 | 0.64 |
| N,N-Diethanol-Oleamide | 93-83-4 | 3.82 |

| | |
|---|---|
| Total (Wt %) | 100.0 |
| Total active CI (wt %) | 74.68 |

TABLE 4
Composition C

| Component | CAS No. | Weight % |
|---|---|---|
| 2-Butoxyethanol | 111-76-2 | 15.48 |
| Dimer fatty acid | 61788-89-4 | 20.61 |
| Tall Oil Fatty Acid | 61790-12-3 | 8.81 |
| Fatty Amide Polymer | 68410-23-1 | 12.31 |
| Monoethanolamine | 141-43-5 | 3.43 |
| Benzalkonium chloride | 68424-85-1 | 28.28 |
| Fatty acids, C18-unsatd., dimers, | 68551-92-8 | 5.11 |
| ethoxylated | | |
| Tall Oil, Diethylenetriamine | 68442-97-7 | 2.48 |
| Imidazoline | | |
| Alkylaryl Sulfonate | 151911-63-6 | 0.64 |
| Alkyl benzene sulfonic Acid | 68584-22-5 | 1.575 |
| Ethoxylated Nonylphenol | 9016-45-9 | 1.27 |

| | |
|---|---|
| Total % | 100.00 |
| Total active CI % | 75.0 |

TABLE 5
Composition D

| Description | CAS No. | Weight. % |
|---|---|---|
| 2-Butoxyethanol | 111-76-2 | 15.48 |
| Dimer fatty acid | 61788-89-4 | 20.61 |
| Tall Oil Fatty Acid | 61790-12-3 | 8.81 |
| Fatty Amide Polymer | 68410-23-1 | 12.31 |
| Monoethanolamine | 141-43-5 | 3.43 |
| Benzalkonium chloride | 68424-85-1 | 28.28 |
| Fatty acids, C18-unsatd., dimers, | 68551-92-8 | 5.11 |
| ethoxylated | | |
| Tall Oil, Diethylenetriamine | 68442-97-7 | 2.48 |
| Imidazoline | | |
| Alkylaryl Sulfonate | 151911-63-6 | 0.64 |
| Alkyl benzene sulfonic Acid | 68584-22-5 | 1.575 |
| Ethoxylated Octylphenol | 9036-19-5 | 1.27 |

| | |
|---|---|
| Total % | 100.00 |
| Total active CI % | 75.0 |

TABLE 6
Bubble Cell Test Results

| | Inhibited Corrosion | % Inhibition versus |
|---|---|---|
| | Rate 15 h after CI | Blank at Same |
| Composition | Injection (mpy) | Time in Test (%) |
| Blank | 407 | N/A |
| Composition A | 367 | 9.9 |
| Composition B | 313 | 23 |
| Composition C | 304 | 25 |
| Composition D | 268 | 34 |

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above methods without departing from the scope of the disclosure, it is intended that all matter contained in the above description shall be interpreted as illustrative and not in a limiting sense.

1. A corrosion inhibitor composition comprising a nonionic surfactant having a cloud point less than 35° C. at a concentration of 1 wt. % actives, and an oil-soluble corrosion inhibitor, the oil-soluble corrosion inhibitor comprising one or more of:
(i) an imidazoline compound having a structure of Formula 1: 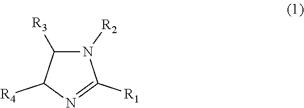
wherein
R₁ is C₁₀ to C₂₃ alkyl or C₁₀ to C₂₃ alkenyl;
R₃ and R₄ are independently hydrogen or C₁ to C₆ alkyl;
R₂ is C₁ to C₆ alkyl substituted with —N(R₅)(R₆) or —NHC(O)R₇,
R₅ and R⁶ are independently hydrogen or —C(O)R₈;
R₇ is C₁₀ to C₂₀ alkyl or C₁₀ to C₂₀ alkenyl; and
R₈ is hydrogen or C₁ to C₆ alkyl;
or a tautomer thereof;
(ii) a dimer fatty acid, a trimer fatty acid, or a combination thereof;
(iii) a tall oil fatty acid or maleated tall oil fatty acid;
(iv) a fatty amide polymer; or
(v) an alkoxylated unsaturated fatty acid or fatty acid dimer.

2. The corrosion inhibitor composition of claim 1, wherein the nonionic surfactant comprises an alkoxylated alkylphenol, an alkoxylated alcohol, an ethylene oxide/propylene oxide copolymer, or a combination thereof.

3. The corrosion inhibitor composition of claim 1, wherein the nonionic surfactant comprises an ethoxylated octylphenol having an average of 5 to 10 ethylene oxide units per molecule, an ethoxylated nonylphenol having an average of 6 to 12 ethylene oxide units per molecule, an ethoxylated branched secondary alcohol having an average of 6 to 10 ethylene oxide units per molecule, and ethoxylated isodecyl alcohol having an average of 4 to 8 ethylene oxide units per molecule, or a combination thereof.

4. (canceled)

5. The corrosion inhibitor composition of claim 1, wherein the nonionic surfactant comprises an ethoxylated octylphenol having an average of 9 or 10 ethylene oxide units per molecule.

6. The corrosion inhibitor composition of claim 1, further comprising an anionic surfactant in the anionic surfactant comprises a C₁₀-C₂₀ alkyl benzyl sulfonic acid, wherein the C₁₀-C₂₀ alkyl benzyl sulfonic acid is selected from decyl benzyl sulfonic acid, dodecyl benzyl sulfonic acid, tetradecyl benzyl sulfonic acid, or combinations thereof.

7. (canceled)

8. (canceled)

9. The corrosion inhibitor composition of claim 6, wherein the anionic surfactant comprises linear dodecyl benzyl sulfonic acid.

10. The corrosion inhibitor composition of claim 1, further comprising a quaternary ammonium compound having the structure of Formula 2, 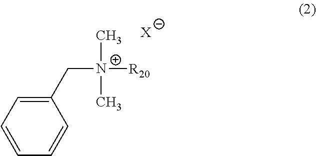
wherein
R₂₀ is C₆ to C₂₀ alkyl or C₆ to C₂₀ alkenyl, C₈ to C₁₈ alkyl, C₈ to C₁₆ alkyl, or C₈ to C₁₂ alkyl and
wherein
the quintenary ammonium compound is present in an amount of from about 1 wt % to about 80 wt % based on a total weight of the corrosion inhibitor composition.

11.-13. (canceled)

14. The corrosion inhibitor composition of claim 1, further comprising a pH adjusting agent, wherein the pH adjusting agent is an alkylamine or an alkanolamine, and is present in an amount of from about 1 wt. % to about 20 wt % based on a total weight of the corrosion inhibitor composition.

15.-16. (canceled)

17. The corrosion inhibitor composition of claim 14, wherein the alkanolamine comprises monoethanolamine.

18. The corrosion inhibitor composition of claim 1, wherein the oil-soluble corrosion inhibitor comprises the imidazoline compound having the structure of Formula 1, wherein R₁ is:
(i) C₁₅ to C₂₃ alkyl or C₁₅ to C₂₃ alkenyl;
(ii) C₁₇ to C₁₉ alkyl or C₁₇ to C₁₉ alkenyl; or
(iii) C₁₇ alkenyl.

19.-21. (canceled)

22. The corrosion inhibitor composition of claim 18, wherein R₂ is C₁ to C₆ alkyl substituted with —N(R₅)(R₆), C₂ to C₄ alkyl substituted with —N(R₅)(R₆), or C₂ or C₃ alkyl substituted with —N(R₅)(R₆), wherein R₅ and R₆ are hydrogen.

23.-27. (canceled)

28. The corrosion inhibitor composition of claim 1, wherein the oil-soluble corrosion inhibitor comprises a dimerized fatty acid, a trimerized fatty acid, or a combination thereof.

29. The corrosion inhibitor composition of claim 28, wherein the oil-soluble corrosion inhibitor comprises a C₃₆-dimerized fatty acid and a C₅₄-trimerized fatty acid.

30. The corrosion inhibitor composition of claim 1, wherein the oil-soluble corrosion inhibitor comprises the fatty amide polymer, wherein the fatty amide polymer is a reaction product of polyalkylenepolyamines and fatty acid comprising C₁₆-C₂₄ unsaturated dimers, C₁₈ unsaturated dimers, or a maleated C₁₆-C₂₄ fatty acid.

31.-34. (canceled)

35. The corrosion inhibitor composition of claim 1, wherein the oil-soluble corrosion inhibitor comprises the alkoxylated unsaturated fatty acid dimer, wherein the alkoxylated unsaturated fatty acid dimer comprises an ethoxylated C₁₈-unsaturated fatty acid dimer.

36. (canceled)

37. The corrosion inhibitor composition of claim 1, wherein the oil-soluble corrosion inhibitor comprises the tall oil fatty acid.

38. The corrosion inhibitor composition of claim 1, further comprising a solvent selected from an aromatic solvent, ethylene glycol monobutyl ether (EGMBE), methanol, isopropyl alcohol, water, monoethylene glycol, diethylene glycol, propylene glycol, 2-ethylhexanol, or a combination thereof, wherein the solvent is present in a range of from about 1 wt. % to about 90 wt. % based on a total weigh of the corrosion inhibitor composition.

39.-41. (canceled)

42. The corrosion inhibitor composition of claim 1, wherein the oil-soluble corrosion inhibitor comprises from about 1 wt. % to about 90 wt. % based on a total weight of the corrosion inhibitor composition, wherein the nonionic surfactant comprises from about 1 wt. % to about 20 wt. % based on the total weight of the corrosion inhibitor composition.

43.-44. (canceled)

45. A method for treating a subterranean hydrocarbon-containing reservoir comprising contacting a hydrocarbon fluid with the corrosion inhibitor composition of claim 1.

46. A method for inhibiting corrosion in a hydrocarbon transportation or storage system comprising contacting a hydrocarbon fluid in the hydrocarbon transportation or storage system with the corrosion inhibitor composition of claim 1.

47.-48. (canceled)
